(19) United States
(12) Patent Application Publication
(10) Pub. No.: US 2003/0102218 A1
(43) Pub. Date: Jun. 5, 2003

(54) Head-disk stiction reduction

(76) Inventors: James Dillon Kiely, Sewickley, PA (US); Emil John Catoc Esmenda, Pittsburgh, PA (US); Yiao-Tee Hsia, Wexford, PA (US)

Correspondence Address: MOSER, PATTERSON & SHERIDAN, LLP, Suite 250, 350 Cambridge Avenue, Palo Alto, CA, 94306, US

(21) Appl. No.: 10/338,570

(22) Filed: Jan. 7, 2003

Related U.S. Application Data
(63) Continuation of application No. PCT/GB97/02011, filed on Jul. 28, 1997.
(60) Provisional application No. 60/346,433, filed on Jan. 7, 2002.

(51) Int. Cl. G01N 27/26

(52) U.S. Cl. 204/547; 205/687; 204/643

(57) ABSTRACT

Magnetic disk drive head/disk stiction is reduced by applying an electrostatic field between the head and the disk as the head dwells in contact with the disk surface. Just before the disk drive begins disk rotation in order that the heads take off, the electrostatic field is removed.

### CROSS-REFERENCE TO RELATED APPLICATIONS

This application claims benefit of U.S. provisional patent application serial No. 60/346,433, filed on Jan. 7, 2002, which is hereby incorporated by reference.

### BACKGROUND OF THE INVENTION

1. Field of the Invention

The invention relates to the reduction of stiction between to bodies and more particularly relates to field of disk drives and the reduction of head-disk stiction.

2. Description of the Related Art

In order for the areal density of magnetic disk drives to continue to increase, the disk drive's head/disk spacing must continue to decrease. In order for head/disk spacing to continue to decrease, both the heads and the media interfacing surfaces must be made smoother. However, smooth surfaces, as opposed to rough surfaces, exhibit high static friction, otherwise known as stiction in the disk drive art. When stiction is high, wear is accelerated and, if very high, the torque required to overcome stiction may surpass that generated by the spindle drive motor. To the extent that disk drive designs continue to land heads on the disk surface during power reduction or power off conditions, stiction remains an increasingly important issue that must be addressed by disk drive designers.

Stiction is caused by a combination of interfacial friction and interfacial liquid meniscus forces. The greater the lubricant contact area between the head and the disk surfaces, the greater the meniscus forces and the greater the stiction.

Conventional means for reducing stiction include artificially increasing the roughness of a landing zone on media and/or artificially increasing the roughness on certain regions of the head's air-bearing surface or by providing bumps or pads on the air bearing surfaces. When the media is roughened to provide a landing zone, a segment of the disk that could otherwise be used for data storage is sacrificed. This is undesirable in today's disk drives; and as areal density increases, the storage capacity sacrificed by this landing zone increases. Attempts to employ artificially roughened heads on unroughened, smooth media have been unsuccessful in reducing stiction sufficiently. Other methods of reducing stiction are needed.

SUMMARY OF THE INVENTION

The invention comprises reducing stiction between two bodies separated by a lubricant through the application of electrostatic fields when the two bodies are dwelling statically. The electrostatic field is removed prior to causing the two bodies to begin sliding contact.

In a magnetic disk drive, the electrostatic field is created by applying a small voltage between the head and the disk while disk rotation is stopped and the head is dwelling on the disk. This voltage is removed just prior to applying power to the spindle motor. The spindle motor overcomes stiction and disk rotation begins.

The applied electrostatic field creates a capacitance attraction between the head and the disk. This attraction squeezes lubricant away from the interface between the two. When the electric field is removed, the capacitance attraction is removed thereby causing a net separation force between the head and disk. However, the lubricant is viscous. It does not immediately flow back to replace the lubricant that was squeezed out does. The increased separation between the head and disk coupled with the slowness of lubricant movement creates voids in the lubricant contact area between the head and disk. This reduction in lubricant contact area reduces lubricant meniscus forces between head and disk and the lubricant. The reduction in meniscus forces in turn reduces stiction.

Disk drive lubricants exhibit dielectrophoresis. The applied electrostatic field causes lubricant to move and spatially aggregate at locations of highest field intensity which are the areas of closest contact between the head and disk. When the head includes bumps or pads, the lubricate aggregates around these points and thins elsewhere. This, in turn, reduces the surface area of contact between the disk lubricant and interfacing surfaces. The reduction in surface area of contact reduces the meniscus force between the lubricant and the interfacing surfaces. The reduction in meniscus forces reduces stiction.

Both effects, squeeze and dielectrophoresis are present when the electric field is applied and coact to reduce stiction when the electric field is removed.

### BRIEF DESCRIPTION OF THE DRAWINGS

FIG. 1 is a schematic view of the essential components of the disk drive necessary to carry out the present invention.

FIG. 2 is a schematic of an additional lead connected between a flex circuit and a magnetic head that applies the electrostatic voltage of the present invention to the head.

FIG. 3 is a chart comparing stiction values with and without the invention.

FIG. 4 is a chart summarizing the reduction in stiction.

FIG. 5 is an ellipsometric image of a disk showing lubricant thickness when a head has been dwelling on the disk with an electrostatic voltage applied.

FIG. 6 is an ellipsometric image of the disk of FIG. 5 one day after the electrostatic voltage has been removed.

### DETAILED DESCRIPTION OF THE PREFERRED EMBODIMENTS

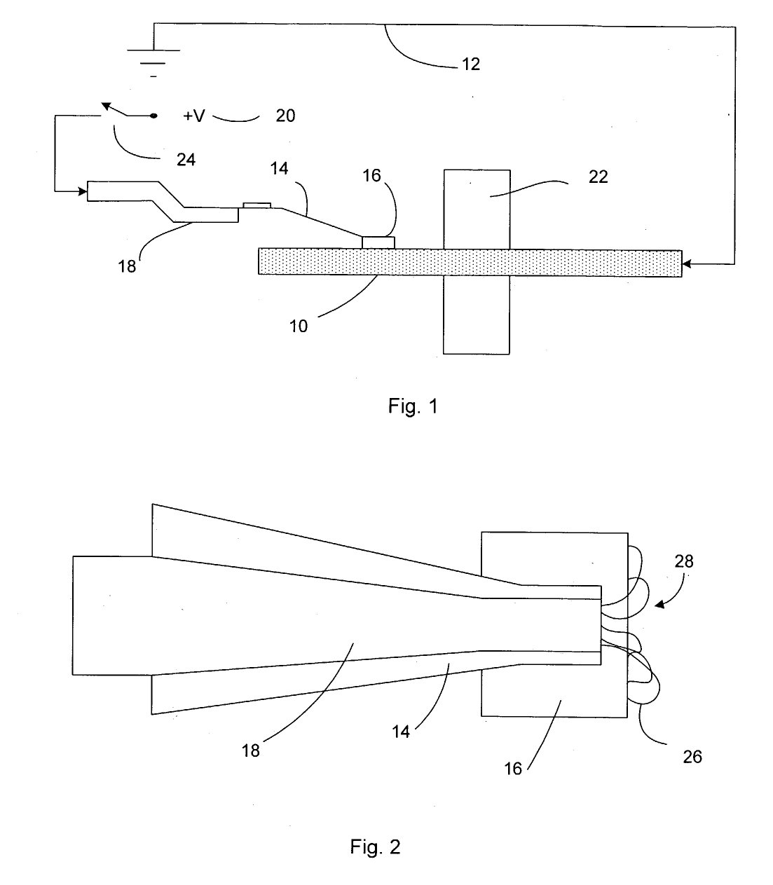

FIG. 1, illustrates the essential disk drive components required to implement the current invention. Shown in the figure is magnetic disk 10 mounted on disk drive spindle 22. Magnetic head 16, which is mounted on flexure 14, is shown in contact with the magnetic disk 10. In most disk drives, this point of contact would be located at a landing zone which is located adjacent spindle 22.

Flexure 14 is in turn connected to a flex circuit 18, that is electrically connected, through switch 24, to positive voltage supply 20. There are two possible means for electrically connecting the head 16 to flex circuit 18: a first means is to simply apply the voltage to the flexure 14, which in turn supplies the voltage to the head 16. Alternatively, as shown in FIG. 2, a separate lead 26 may be provided between the flex circuit 18 and the head 16 if it is desired to electrically isolate the head 16 from flexure 14. Preferably, this lead 26 comprises one of the leads 28 that bond to bonding pads (not shown) and connect the head's active transducers components to the flex circuit 18.

The magnetic disk 10 is further connected to ground 12. Any number of means may be used to accomplish this. However the most common means would be to provide an electrically conductive bearing fluid or grease in the disk drive's spindle motor (not shown) that drives spindle 22.

In operation, the switch 24 is closed to connect voltage source 20 to the head after the disk 10 has come to a halt. This “dwell voltage” creates an electrostatic field between the head and disk across the lubricant. It is left connected until it is again desired to begin rotation of the magnetic disk 10 for normal disk drive operation. At that time, switch 24 is opened to disconnect voltage 20 from the head. Alternatively to save power, it may be sufficient to apply the dwell voltage for a short time just prior to the start of disk rotation.

The preferred electric dwell voltage differential between the head 16 and disk 10 is on the order of two volts. Dwell voltages may range, however, from a effective lower limit, approximately 100 mV, to an effective upper limit set primarily to avoid potentially harming the read/write transducer. Two volts is the upper limit with today's highly sensitive transducers. However, dwell voltages different from these voltages may also be used without limitation on the scope of the present invention.

In order to conserve power, it is desirable that the lubricant not be conductive. This is also desirable to maximize the “capacitor” effect of having the head and disk cooperate together as conductive “plates” separated by a dielectric. The lubricant commonly used in disk drives, including the functional and non functional lubricants described herein, are dielectrics.

Dielectrophoresis

Lubricants commonly used in magnetic disk drives are dielectrics. These dielectric lubricants have recently been shown to be susceptible to dielectrophoretic effects. The lubricants move when they are exposed to an electric field gradient.

Dielectrophoresis (“DEP”) is an electrical phenomenon that allows particles to be trapped or manipulated by applying nonuniform electrical fields. These non uniform electric fields induce electrical polarization in the particles. Depending on the polarizability of the particles with respect to the medium in which it is suspended, they will move toward or away from regions of high field intensity. Motion toward the regions of high field intensity is termed positive dielectrophoresis. Motion away from them is termed negative dielectrophoresis.

Unlike electrophoresis, no overall electrical charge on the particle is necessary for DEP to occur. Instead, the phenomenon depends on the magnitude and temporal response of an electric dipole moment induced in the particle, and on the force produced as a consequence of the electric field gradient acting across the particle. The magnitude of the dielectrophoretic force is proportional to the square of the electric field gradient.

The most commonly used disk drive lubricants, so-called functional lubricants, exhibit a strong dielectrophoresis effect. Examples of functional lubricants include functional perfluoropolyether lubricants (e.g., FOMBLIN® Z-DOL and Z-tetraol), available from Ausimont USA, a subsidiary of Montedison S.P.A of Milan, Italy.

However, even non-functional lubricants that are also used on occasion exhibit some dielectrophoresis, though not as pronounced as functional lubricants. An exemplary nonfunctional lubricant is FOMBLIN® Z, available from Ausimont USA, a division of Montedison, S.P.A., of Milan Italy. The use of a functional lubricant is preferred to enhance dielectrophoresis in the presence of the applied electrostatic field of the present invention.

Capacitive Squeeze and Dielectrophoresis

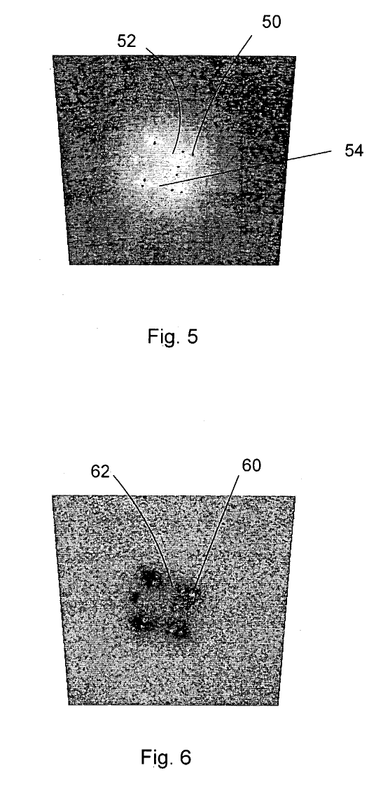

FIG. 5 is an ellipsometric image from a disk that had 2V applied between it and a head. In FIG. 5, the lighter areas are the disk lubricant. The darker areas, particularly at the dark points of contact 50, are areas of less or no lubricant. The applied electrostatic fields has caused the lubricant to accumulate and form menisci in regions 52 near points contact 50 between the head and the disk. This accumulation in turn thins the lubricant at locations 54 away from these points of contact 50.

As seen in FIG. 5, a head contacts a disk surface via a plurality point contacts, dark spots 50, scattered about the head/disk interface. These point contacts 52 are caused by carbon bumps or pads formed on the rails of a slider that are intended to reduce the area of contact between disk and the head. They may also be caused by unintended asperities.

FIG. 6 is an ellipsometric of the same disk area imaged one day later during which time no dwell voltage was applied between the head and the disk. The change in lubricant thickness from the first image shown in FIG. 6. One day is sufficient time for lubricant to reflow back to its equilibrium state. The areas 62 that had thicker lubricant due to dielectrophoretic attraction now shows a negative change in lube thickness and appear dark. Likewise, the areas 60 under the points of contact show a positive change in lubricant thickness. They appear brighter.

FIGS. 5 and 6 together show that capacitive squeeze expels lubricant from beneath the bumps or pads. The dwell voltage on the head increases capacitive force, bringing the head closer to the disk. This increased force between head and the disk squeezes some lubricant out from the interface between the two. The figures also show that removing the dwell voltage lifts the head slightly, back towards its ‘normal,’ zero-volts-applied, position. This permits the squeezed-out lubricant at the points of contact 50/62 to flow back.

Disk lubricant is highly viscous and flows slowly. When the dwell voltage is removed, the lubricant cannot immediately react to this sudden movement. The accumulated lubricant menisci either break or shrink. Both broken menisci and less meniscus contact area result in lower stiction.

### EXAMPLES

In the succeeding examples, a magnetic head comprising a conductive A1203/TiC slider body 16 was connected to a 2V DC voltage 20 through a conductive lead 26 from the slider bond pads to the flex circuit 18. The head's reader and writer transducers were not connected in this configuration, as this investigation was focused only on stiction performance. The disk remained at ground, giving a 2V potential across the head-disk interface. Several types of experiments using the configuration were conducted and all have shown that dwell voltage reduces stiction.

The heads were mounted on a tribology spinstand to measure stiction. A tribology spinstand is a device that measures stiction and friction forces between heads and disks in conditions that mimic those found in a disk drive. In the spinstand, the head is mounted on a calibrated strain gauge force sensor. The strain gauge output is combined with the disk rotational rate to determine head-disk forces at the start of spin-up (stiction) and during flying (friction).

### Example 1

In a first set of experiments, a production head and production disk were loaded onto a tribology spinstand, with the head making contact with the data zone of the disk. In the experiment, the head was allowed to dwell in one location for one hour. This is sufficient time for mobile lubricant to move either as a result of the capacitance squeeze effect or as a result of the menisci migrating to areas of high electric field strength due to dielectrophoresis. After one hour, the stiction value was measured by accelerating the disk and measuring the interfacial force. After flying for 2.8 seconds at 7200 rpm, the disk was decelerated to zero RPM and the head was allowed to dwell for another hour. During this second dwell, a voltage (2V DC) was applied to the head.

After dwelling one hour with the voltage applied, the voltage was reduced to zero. Within 20 seconds of removing the voltage, the disk was then accelerated and the stiction force measured. The head was allowed to fly for 2.8 seconds, then it was brought back to the zero rpm. The head was then allowed to dwell for one hour with no applied voltage. The disk was then again accelerated and stiction measured. This cycle of alternating one-hour dwells (0V dwell, then 2V dwell, then 0V dwell, etc.) was continued until twelve stiction measurements of each type of prior dwell conditions, either 0V or 2V applied, had been performed.

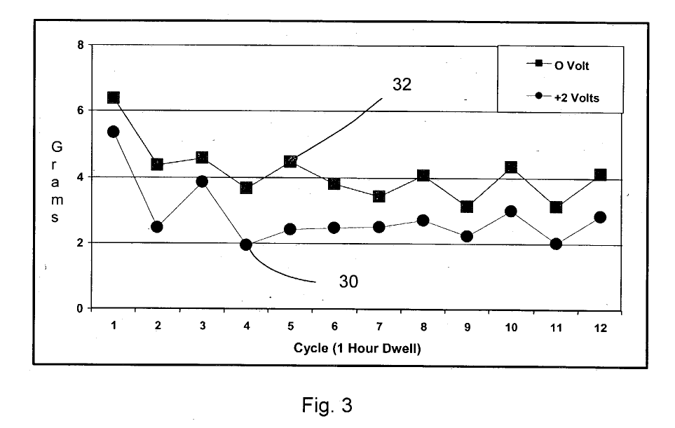

FIG. 3 is a chart of the results of this test. The chart compares stiction in grams vs. test cycles. The data shows a significant decrease in stiction when 2V DC was applied, line 30, versus when 0V DC is applied, line 32. A paired T-test analysis on this data yielded a mean decrease of 1.3 grams (a reduction of 32%) and a 100% confidence that there was a stiction decrease when a dwell voltage was first applied.

### Example 2

In another set of experiments, head and disk combinations were put through contact-start-stop tests that included cycles of seeking (moving from the inner diameter of the data zone to the outer diameter at 10 Hz for 3 seconds). This type of test is believed to accelerate lubricant accumulation on the head. After 5,000 cycles, the head was allowed to dwell on the data zone of the disk for 24 hours. Stiction was then measured. This is a generally accepted test procedure for measuring “dwell stiction.”

During the first 24-hour dwell period, no voltage was applied to the head. After stiction values were measured, the test was repeated; but two volts DC was applied during the second 24-hour dwell period.

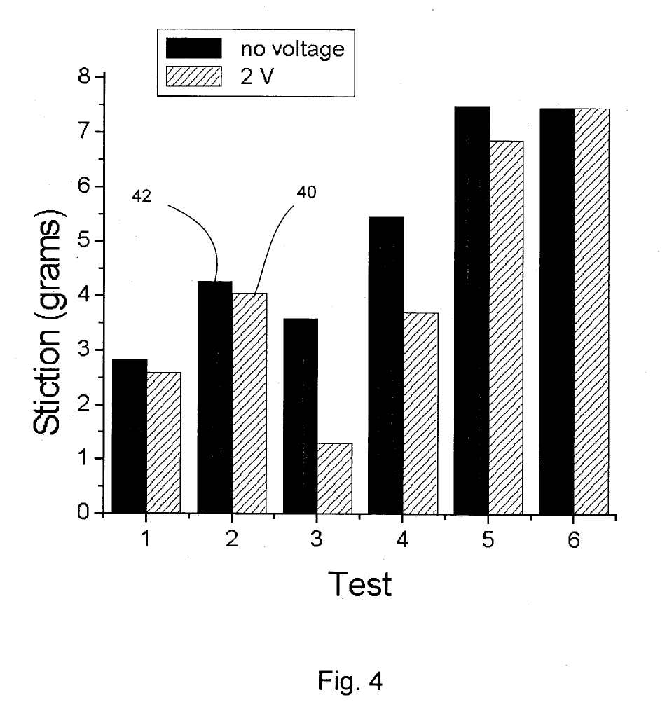

FIG. 4 is a chart of the test data from this experiment. It compares measured stiction values in grams of six pairs of tests. The data shows a decrease in stiction in the case of dwell with an applied voltage, bars 40, versus those with zero volts, bars 42. The mean decrease in stiction in these paired tests was 0.85 grams, with 92% confidence that there was a decrease in stiction.

The above description of the preferred embodiments is not by way of limitation on the scope of the appended claims. In particular, those of ordinary skill in the art may substitute other lubricants for the disclosed lubricants and other electrical structures for applying an electrostatic field between the head and the disk than those described here.

We claim:

1. Apparatus for reducing stiction between a first body and a second body, comprising:
a first body lubricated with a lubricant;
a second body arranged for both selective stationary and sliding contact with said lubricated first body; and
circuitry selectively connecting a voltage source between the first body and the second body during dwelling periods of stationary contact.

2. Apparatus according to claim 1 wherein the lubricant comprises a functionalized perfluoropolyether.

3. Apparatus according to claim 1 wherein the lubricant comprises a dielectrophoretic lubricant.

4. Apparatus according to claim 1 wherein the dwell voltage from said voltage source is on the order of 100 millivolts to two volts.

5. Apparatus according to claim 1, wherein said first body is a magnetic disk and said second body is a magnetic head and said circuitry comprises an electrical connection to the head.

6. Apparatus according to claim 1 wherein said first body is a magnetic disk and said second body is a magnetic head and said circuitry comprises means for grounding the magnetic disk.

7. Apparatus according to claim 1 wherein said first body is a magnetic disk and said second body is a magnetic head and said circuitry comprises a flex circuit with a lead connected to the magnetic head.

8. Apparatus according to claim 1 wherein the lubricant comprises a dielectric.

9. Apparatus according to claim 1 wherein said circuitry comprises a switch that may be selectively opened just prior to the start of sliding contact.

10. A method for reducing stiction between two bodies separated by a lubricant, comprising:
selectively applying a dwell voltage between the two bodies while they are dwelling in stationary contact.

11. The method according to claim 10 wherein the lubricant comprises a functionalized perfluoropolyether.

12. The method according to claim 10 wherein the dwell voltage is on the order of one hundred millivolts to two volts.

13. The method according to claim 10, wherein one of the two bodies is a magnetic head and said step of applying a dwell voltage comprises electrically connecting a voltage source to the head.

14. The method according to claim 10 wherein one of the two bodies is a magnetic disc and said step of applying a dwell voltage comprises grounding the magnetic disk.

15. The method according to claim 13 wherein said step of applying a dwell voltage comprises connecting a flex circuit lead to the magnetic head.

16. The method according to claim 10 wherein said lubricant comprises a dielectric lubricant.

17. The method according to claim 10 further comprising removing the dwell voltage just prior to starting sliding contact between the two bodies.

18. Apparatus for reducing stiction between a magnetic head and a magnetic disk, comprising:
a magnetic disk lubricated with a lubricant; and
means for selectively applying a dwell voltage between a magnetic head and the magnetic disk when the head is dwelling on the disk.

19. Apparatus according to claim 18 wherein said means for selectively applying a dwell voltage includes a switch that may be opened just prior to the start of disk rotation.

20. Apparatus according to claim 18 wherein said means for selectively applying a dwell voltage includes a conductive spindle motor lubricant.
